(19) United States
(12) Patent Application Publication
(10) Pub. No.: US 2006/0146829 A1
(43) Pub. Date: Jul. 6, 2006

(54) Network system, nodes connected thereto and data communication method using same

(75) Inventor: Hiroaki Yamada, Yokohama (JP)

Correspondence Address: BEYER WEAVER & THOMAS LLP, P.O. BOX 70250, OAKLAND, CA, 94612-0250, US

(73) Assignee: OMRON Corporation

(21) Appl. No.: 11/323,648

(22) Filed: Dec. 29, 2005

(30) Foreign Application Priority Data
Jan. 4, 2005 (JP) 2005-000296

(51) Int. Cl. H04L 12/56; H04J 3/26

(52) U.S. Cl. 370/392; 370/432

(57) ABSTRACT

A plurality of nodes are connected to a network and share data among them to form a network system. Each node has a communication interface for transmission and reception of data by full duplex transmission through the network and a virtual memory for storing data to be transmitted. Multicast addresses are set to the data to be transmitted in units of frames, and the communication interface serves to transmit data by multicast together with their corresponding multicast addresses. Each node, when data to be received thereby are set, serves to store one or more of multicast addresses of frames containing data to be transmitted from other nodes by multicast and to be received thereby. The communication interface of each node, when receiving frames transmitted by multicast, serves to copy the data of those of the received frames having a multicast address that matches one of the stored multicast addresses and to discard frames with a multicast address that does not match any of the stored multicast addresses.

Priority is claimed on Japanese Patent Application 2005-000296 filed Jan. 4, 2005.

### BACKGROUND OF THE INVENTION

This invention relates to a network system, as well as nodes that are connected to and a communication method using such a network system.

Programmable controllers are commonly used as a control device for factory automation (FA). Such a programmable controller (PLC) is typically formed as an appropriate combination of a plurality of units of various kinds such as a power unit for supplying electrical power, a CPU unit for controlling the whole PLC, an input unit for inputting signals from switches and sensors that are set at appropriate positions on a production apparatus or an equipment apparatus for the FA, an output unit for outputting control signals to actuators or the like, and a communication unit for connecting to a communication network.

The control by the CPU unit of a PLC is carried out by cyclically repeating the processes of taking in a signal inputted through the input unit to the I/O memory of the CPU unit (IN-refresh), carrying out a logical calculation based on a user program formed by a preliminarily registered ladder language (calculation execution), writing the results of the calculation execution into the I/O memory and transmitting them to the output unit (OUT-refresh), and thereafter carrying out the so-called peripheral processes.

A system including such a PLC sometimes carries out a synchronized control or a coordinated control by providing a plurality of communication nodes for its PLC and other controllers, connecting them by a network and holding data in common among them. The so-called datalink format is one of the methods of holding data in common among nodes in such a situation.

In the datalink format, as described in Japanese Patent 3329399 and Japanese Patent Publication Tokkai 06-014033, datalink areas are set as a virtual memory at specified positions in the memory of each node. Each of these datalink areas includes an “own-node area” for storing one's own data to be commonly shared and an “other-node area” for storing data that have been transmitted from other nodes. These datalink areas are set next to each other, and each node is adapted to transmit its own data stored in its own-node area through the network. The data thus transmitted are received by all the other nodes connected to the network and stored in their other-node areas. Thus, all nodes can share data with the other nodes belonging to the same datalink.

FIG. 1 shows a network with an example of prior art datalink, having a plurality of nodes (such as PLCs) 1 connected through a network 2 and each node 1 having a datalink area (virtual memory) set therefor. In FIG. 1, areas shaded in black each represent an own-node area and the areas shaded in white (or not shaded) each represent an other-node area. The operations for reading and writing data will be explained next with reference to Node (1) of FIG. 1.

As Node (1) writes data into the virtual memory (1) assigned to itself, the same data are transmitted simultaneously together to the virtual memories (1) of Nodes (2), (3) and (4) through the network 2. As data are transmitted from Nodes (2), (3) and (4), Node (1) receives them into corresponding virtual memories (2), (3) and (4), respectively. Node (1) serves to read out data stored in virtual memories (1)-(4) and to make use of them. In other words, Node (1) possesses in its virtual memories (2)-(4) data possessed by other Nodes (2)-(4) on the network 2 such that the applications of Node (1) can obtain and make use of data of other Nodes (2)-(4) by accessing its virtual memories. This is to say that each node can carry out communications with the other nodes without becoming aware or conscious of the communication routines of the other nodes and as if it is reading from and writing into its own virtual memories because data possessed by any of Nodes (1)-(4) are all shared in common by all Nodes (1)-(4).

Thus, since each node outputs the data stored in its own-node area, all nodes participating in the datalink can share the data with the other nodes. This datalink function is widely being used by PLC networks as a method of sharing data among nodes since it makes it possible to exchange data among a plurality of node (PLCs) without creating any ladder program.

As explained above, however, each node must necessarily transmit the data stored in its own-node area onto the network 2 together and simultaneously. In this situation, if the network 2 is of the half duplex transmission type and if frames having data attached to them are simultaneously transmitted from a plurality of nodes, there will be a collision on the network 2, resulting in a transmission error. For this reason, a common practice is to use a token passing method such that only the node which has gained the possession of a token (the right to transmit) can transmit a frame.

FIG. 2 shows the concept of this token passing method. According to this method, each node serves to transmit data when it possesses the token and passes the token to the next node after transmitting its data, as shown in FIG. 2A. Each frame transmitted from a node specifies the broadcast address (BA) as the destination address and is comprised of a virtual memory address (sometimes referred to as the common memory), the data to be actually transmitted and the token, as shown in FIG. 2B.

The data transmitted from each node are assigned to a virtual memory address space. The node which receives signals is provided with a memory map table which correlates addresses of virtual memories and the addresses of memories in the node and serves to receive necessary data from the data flowing through the network 2 according to this table.

Attempts to share data by the datalink method can encounter a problem. Since communications are made through half duplex transmission by the token passing method, its communication capability depends upon the token circulation, that is, upon the total sum of the times required for the transmission of data from the individual nodes and the total number of the nodes. In the case of the example shown in FIG. 2, Node (1) first transmits by broadcasting Frame 1 that contains the data stored in Area (1) of its own virtual memory, Node (2) then receives the token and transmits by broadcasting Frame 2 that contains the data stored in Area(2) of its own virtual memory, Node (3) then receives the token and transmits by broadcasting Frame 3 that contains the data stored in Area(3) of its own virtual memory, and Node (4) then receives the token and transmits by broadcasting Frame 4 that contains the data stored in Area(4) of its own virtual memory, thereby completing one cycle. Thus, one communication cycle time in this example is the total sum of times during which four nodes transmit their frames. If the number of nodes increases or the volumes of data in the own-node areas to be transmitted increase, therefore, the communication cycle times also become longer.

In most applications, however, there are many situations where not all of the data that flow on the network are actually necessary. In other words, a large portion of the communication cycle time is often a meaningless wait time for a receiver node. Consider Node (1) of FIG. 1, for example. It is not always the case that the data stored in its own-node area (1) to be transmitted are necessarily required by all other Nodes (2), (3) and (4). The data stored in the own-node area are required at least by one of the nodes participating in the datalink. The other nodes which received the data transmitted by broadcasting will each store all of the received data in the corresponding other-node area but it is usually only a portion of the received data that is used by each of the other nodes.

For example, let us assume that there are four nodes in a datalink, as shown in FIG. 1. Let us further assume that data that are transmitted from Node (1) include those used only by Node (2), those used only by Node (3) and those used by all of Nodes (2), (3) and (4). Node (2) will receive all of the data stored in the own-node area (1) of Node (1) but naturally does not use the data that are only for Node (3). Similarly, data received by Node (1) from the other nodes include all different kinds some of which are not used by Node (1).

Thus, it is wasteful to store in the memory such data that are received but are not used because a storage area larger than actually required will be necessary. In addition, operations become complicated if transmission of data that are not used is necessary and work of reading and writing data that are not used is to be necessarily carried out.

In order to reduce the memory capacity, it is possible to extract only necessary data to store them in the memory, instead of causing each node to store all datalinked data that have been received, and to discard the rest. Since all frames that are transmitted by broadcasting are transmitted to the MPU or RAM inside each receiver node, the MPU will be required to judge whether the received data are necessary or not such that unnecessary data can be discarded. This means that there is an extra load on the MPU.

### SUMMARY OF THE INVENTION

It is therefore an object of this invention to provide a network system capable of reducing the load on the nodes connected thereto when they store data in common such that the time required for the network as a whole to transmit and receive the data to be held in common (or its communication cycle time) can be reduced, as well as nodes to be connected to such a network system and a data communication method for such a network system.

A network system according to this invention may be characterized as comprising a network, which may be an Ethernet network, and a plurality of nodes that are connected to this network and are themselves characterized as sharing data in common among themselves. These nodes are further characterized as each having a communication interface for transmission and reception of data by full duplex transmission through the network and each having a virtual memory for storing data which are to be transmitted by itself, having a multicast addresses set in units of frames. The communication interface of each node, when its corresponding node is transmitting data, serves to transmit the data by multicast together with the multicast addresses corresponding to the transmitted data. Each of these nodes, when data to be received thereby are set, serves to store one or more of multicast addresses of frames containing data to be transmitted from other nodes by multicast and to be received by itself. The communication interface of each node serves, when receiving frames transmitted by multicast, to copy to the corresponding node the data of those of the received frames having a multicast address that matches one of the stored multicast addresses and to discard frames with a multicast address that does not match any of the stored multicast addresses.

A node according to this invention is adapted to be connected to a network and to share data in common with other nodes connected to the same network and may be characterized as comprising a communication interface for transmission and reception of data by full duplex transmission through the network, a virtual memory for storing data to be transmitted by itself and multicast addresses in correlation and a memory for storing multicast addresses of frames containing those of the data transmitted by multicast from other nodes that are to be received by itself. The communication interface serves to transmit data by multicast together with the stored multicast addresses and, when frames transmitted by multicast are received, to copy to the corresponding node the data in those of the received frames having a multicast address that matches one of the stored multicast addresses and to discard data in those of the received frames having a multicast address not matching any of the stored multicast addresses.

A data communication method according to this invention for using a network system with a network and a plurality of nodes connected to the network and adapted to share data in common among these nodes may be characterized as comprising the steps of providing each of these nodes with a communication interface for transmission and reception of data by full duplex transmission through this network, providing each of the nodes with a virtual memory for storing data to be transmitted by that node, setting multicast addresses to data in units of frames for transmission, causing the communication interface of one of the nodes to transmit by multicast the data for transmission together with the set multicast addresses, causing each of the nodes for which data to be received are set, to store multicast addresses of frames containing data that are transmitted from other nodes and intended to be received by this (each) node, and causing the communication interface of each of the nodes, when data are thereby received by multicast, to copy to the corresponding node the data contained in those of the frames transmitted by multicast and having a multicast address that matches one of the stored multicast addresses and to discard data in those of the received frames having a multicast address not matching any of the stored multicast addresses. The method may further comprise the steps of causing each of the nodes, when transmitting data, to transmit these data by assigning a same identification number to the frames and causing each of the nodes, when receiving data, to copy the received data to itself only after data in the same number of frames have been received. The method may still further include the steps of causing each of the nodes to record node-identifying data for identifying a data-transmitting node that transmits data to be received by itself and address data of the virtual memory of this data-transmitting node and causing an inquiry to be made to the data-transmitting node regarding multicast address based on the recorded address data and obtaining the multicast address.

A network system according to another embodiment of the invention may be characterized as comprising a network and a plurality of nodes that are connected to this network through a switching hub and share data in common among them. These nodes each have a communication interface for transmission and reception of data by full duplex transmission through the network and a virtual memory for storing data that are to be transmitted by itself and have multicast addresses set in units of frames. The communication interface of each node, when the corresponding node is transmitting data, serves to transmit the data by multicast together with the multicast addresses corresponding to the transmitted data. Each of these nodes, when data to be received thereby are set, serves to store one or more of multicast addresses of frames containing data to be transmitted from other nodes by multicast and to be received by itself. The communication interface of each of these nodes serves, when receiving frames transmitted by multicast, to copy to the corresponding node the data of those of the received frames having a multicast address that matches one of the stored multicast addresses and to discard frames with a multicast address that does not match any of the stored multicast addresses. Each of the nodes serves to transmit data cyclically at its own transmission timing to thereby come to share the transmitted data with the other nodes. Each of the nodes may be further adapted, when transmitting data by dividing the data into a plural number of frames within a same communication cycle, to assign a same identification number to the frames and, when receiving data, to copy the received data to itself only after data in the same number of frames have been received.

### BRIEF DESCRIPTION OF THE DRAWINGS

FIG. 1 shows an example of prior art datalink.

FIGS. 2A and 1B, together referred to as FIG. 2, show the concept of the token passing method.

FIG. 3 shows an example of network system structure embodying this invention.

FIG. 4 is a block diagram for showing the internal structure of the CPU unit and the communication unit that comprise the PLC.

FIG. 5 is a schematic drawing of a network configuration.

FIG. 6 is a drawing for showing the internal structure of the communication unit.

FIG. 7 is a drawing for explaining the operation of an embodiment of this invention.

FIG. 8 shows a memory map table correlating the data of multicast addresses.

FIG. 9 shows an example of another data structure of a memory map table.

FIG. 10 shows an example of memory map table on the transmission side.

FIG. 11 shows an example of memory map table on the reception side.

FIG. 12 shows a process of obtaining a multicast address based on the memory map tables shown in FIGS. 10 and 11.

FIG. 13 shows an example of situation where frames are being transmitted according to the process explained with reference to FIG. 12.

FIG. 14 is a drawing for explaining the operation of another embodiment of this invention.

FIG. 15 is a data flow diagram under the operation explained with reference to FIG. 14.

FIGS. 16 and 17 are a flowchart for showing the functions of the simultaneity judging part.

### DETAILED DESCRIPTION OF THE INVENTION

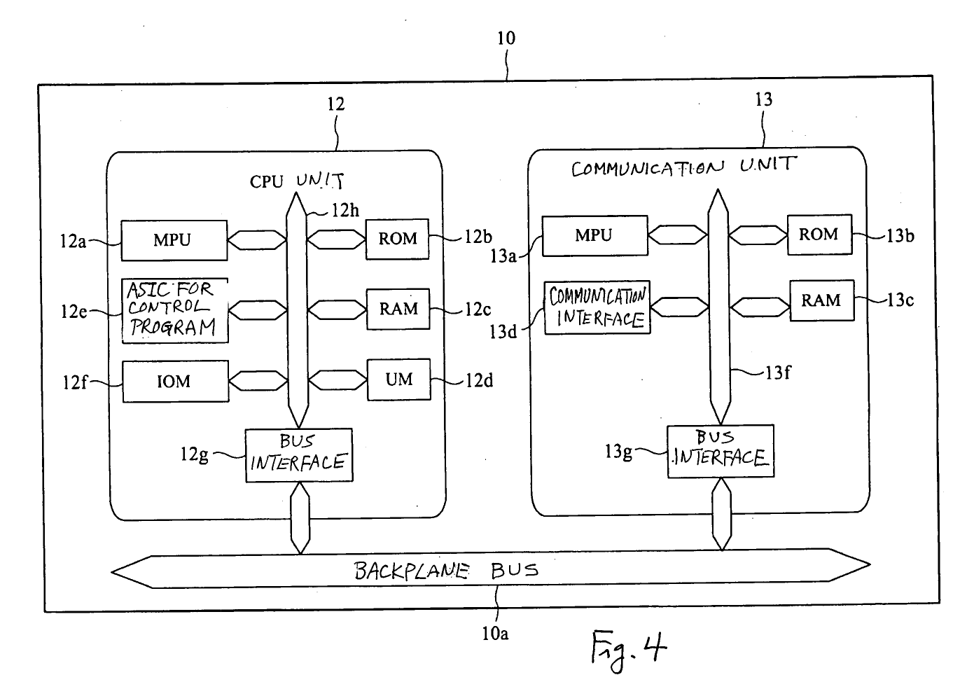

FIG. 3 shows an example of network system embodying this invention, having two PLCs 10 connected to a switching hub 20 serving as a relay through network cables 21 such that data can be exchanged between them through this switching hub 20. Although an example with two PLCs is shown for the convenience of description, a larger number of PLC's are usually connected and there are also examples where nodes other than PLCs may be connected.

Each of the PLCs 10 is comprised of units of various kinds connected such as a electrical power unit 11, a CPU unit 12, a communication unit 13, an input unit 14, an output unit 15 and a special function unit 16. These units are connected through a backplane bus through which data are exchanged on real time in order to control an object to be controlled. It now goes without saying that the example shown in FIG. 3 is not intended to limit the scope of the invention. Units of different kinds may also be connected and some of the units shown in FIG. 3 may be deleted within the scope of the invention.

The power unit 11 is for supplying power to each of the group of units forming the PLC 10. The CPU unit 12 has the function of storing the control program for controlling the system in a programmable manner, carrying out the control program based on IN data taken in from the object of control through the input unit 14 and transmitting obtained results of calculation (OUT data) to the output unit 15. For example, the input unit 14 obtains the conditions (IN data) of input devices such as limit switches and sensors. The obtained IN data are transmitted to the CPU unit 12 at a specified timing (at the time of IN refresh). The output unit 15 serves to cause changes in the conditions of the connected object of control based on the OUT data received from the CPU unit 12. For example, a switch may be operated upon to activate an electrical device (to cause an electrical change) and an air valve may be opened or closed (to cause a mechanical change). The special function unit 16 may be of a type adapted to carry out the control program with the CPU unit 12 or may be a motion controller adapted to control a motor or the like according to a command from the CPU unit 12.

The communication unit 13 is for carrying out communications with other devices (nodes) through the network cable 21. In the case of an Ethernet network according to the present example, the communication unit 13 is a corresponding Ethernet unit. It is through these communication units 13 that PLCs that are at physically separated locations can carry out controls in a mutually cooperating manner.

FIG. 4 shows the internal structure of the CPU unit 12 and the communication unit 13 that comprise the PLC 10. The CPU unit 12 is a unit for controlling the PLC 10 as a whole. From the point of view of hardware structure, the CPU unit 12 is provided with an MPU 12a which is a microprocessor for controlling the operations of the CPU unit 12 as a whole, a ROM 12b which is a memory for storing the system firmware, a RAM 12c which is a memory to be used as a system work area, a user memory (UM) 12d which is a memory for storing the user program, an ASIC 12e for the control program which carries out processes of execution of the user program (commands), interfacing with the communication unit and memory access bus arbitration, an 10 memory (IOM) 12f which is a memory area including a junction area (for storing the IN data received from the input unit and the output data to be transmitted to the output unit) and a data area, and a bus interface 12g, which are all connected to an internal bus 12h through which data can be exchanged among the units, and the units are connected to a backplane bus 10a and can exchange data with other units.

The communication unit 13 is provided with an MPU 13a which is a microprocessor for controlling the operations of the communication unit 13 as a whole, a ROM 13b which is a memory for storing the system firmware, a RAM 13c which is a memory to be used as a system work area, a bus interface 13g for connecting to the backplane bus 10a and also (Ethernet) communication interface 13d connected to the external network 21 for carrying out communications with other nodes. These units are all connected to an internal bus 13f through which data can be mutually exchanged and are also connected to the backplane bus 10a through the bus interface 12g for exchanging data. The ROM 13b serves not only to store the system firmware but also a memory map of the virtual memories.

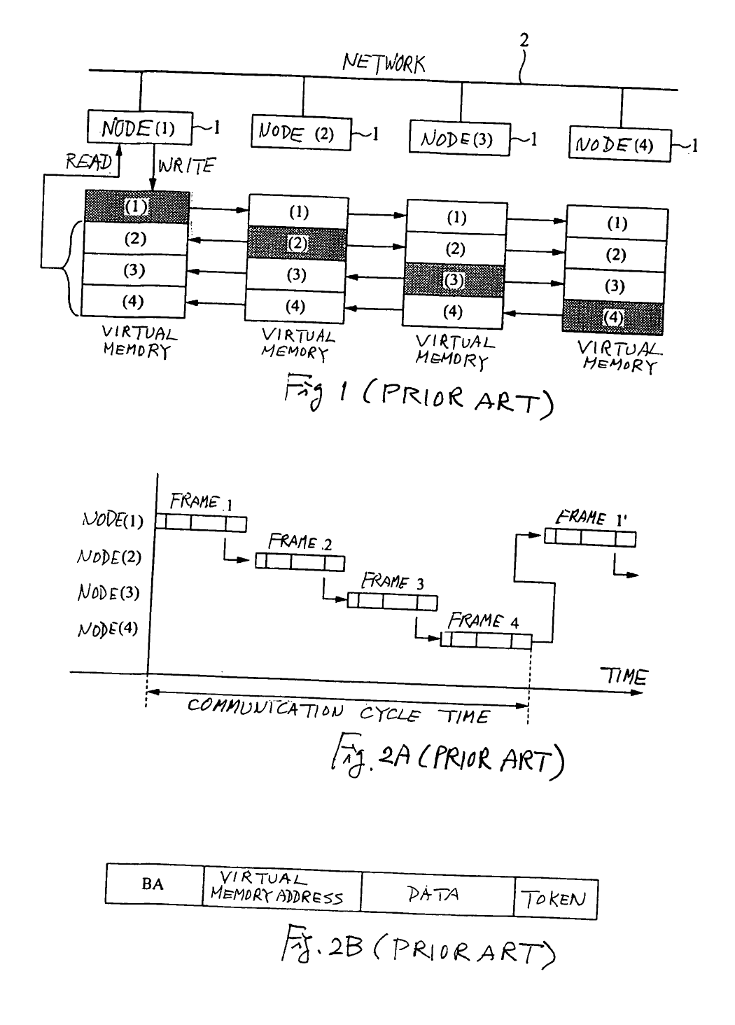

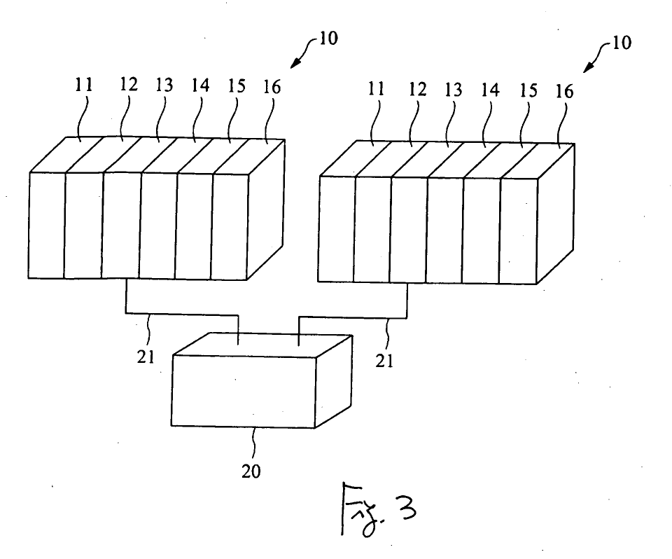

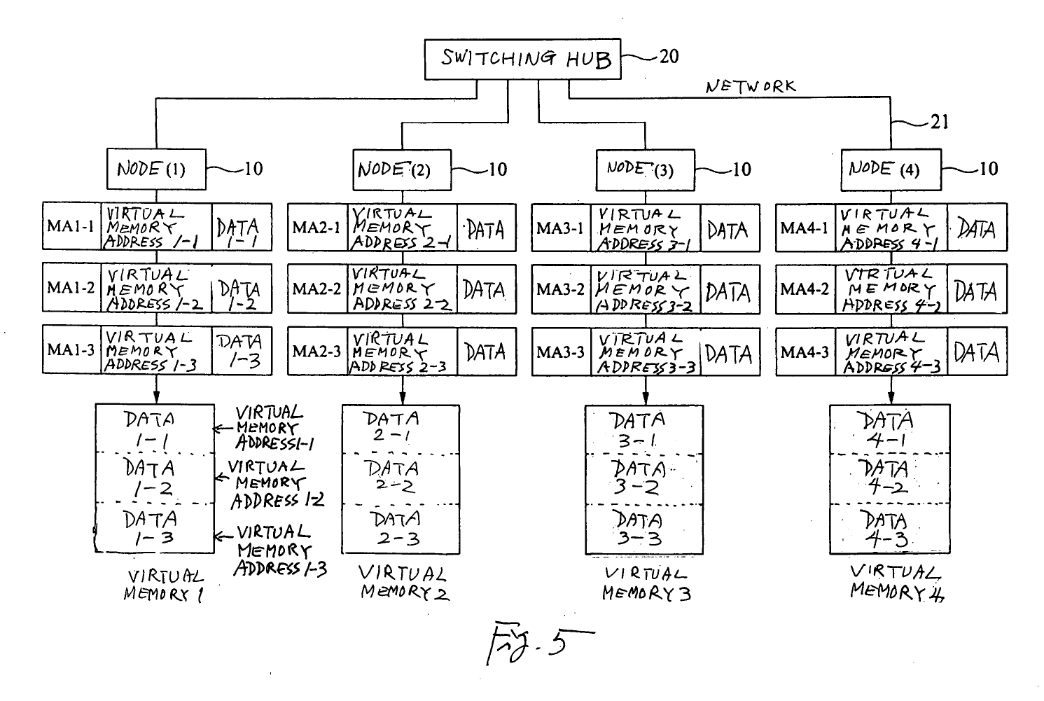

FIG. 5 is a schematic drawing of the network configuration with an emphasis on its data transmission side. Each node (such as a PLC) is adapted to transmit data assigned in a virtual memory address space (data stored conventionally in an own-node area) through multicast. The virtual memory of each node shown in FIG. 5 corresponds to a self-node area shown in FIG. 1. According to the present example, the data stored in each virtual memory address space are transmitted in one frame or by being divided into a plurality of frames. FIG. 5 shows each node transmitting its data by dividing them into three frames but the number of divisions may be different from one node to another, and there may be a node or nodes where data are not divided.

Each virtual memory address space is assigned individual multicast addresses in units of frames that are transmitted. According to the present example, each multicast address consists of “MA”, a “node address”, “-” and an “ID number”. For example, the multicast address of the first virtual memory address 1-1 of Node (1) is “MA1-1”, that of the second virtual memory address 1-2 of Node (1) is “MA1-2”, and that of the third virtual memory address 1-3 of Node (1) is “MA1-3”. The data structure of the transmission frame is in the form of “(multicast address)+(virtual memory address)+(data)” without any token attached.

Each node transmits by multicast the data assigned to its own virtual memory address space at its own timing. By this multicast transmission, the same frame is transmitted by the switching hub 20 to all nodes participating in the network 21.

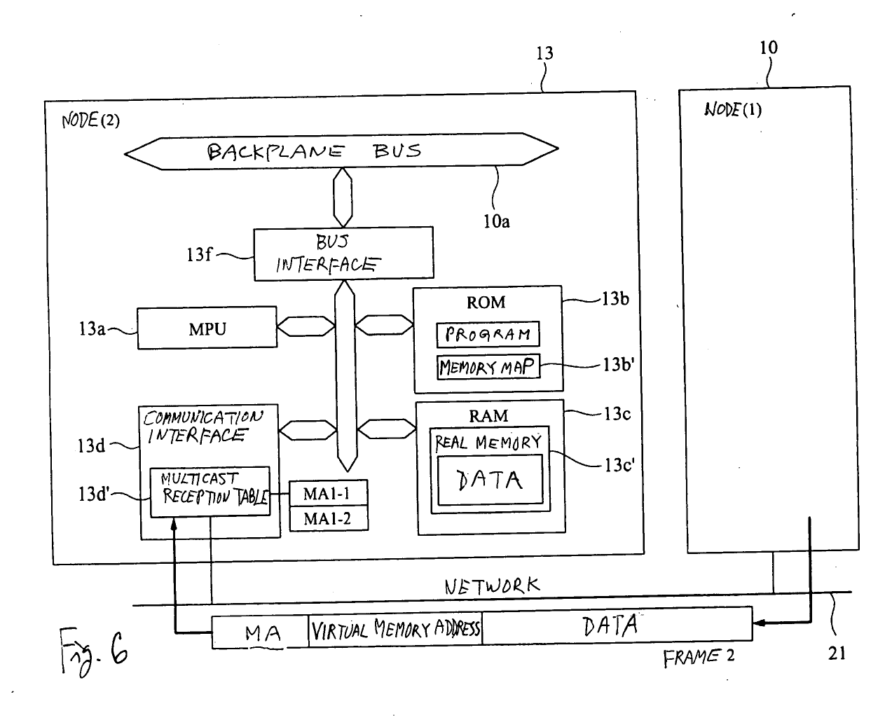

FIG. 6 shows an example of internal structure of the communication unit 13 with an emphasis on its data receiving function. The communication interface 13d (corresponding to Ethernet) is provided with a multicast reception table 13d′ for recording and storing the multicast addresses (“MA1-1” and “MA1-2” of Node (2) in the example show) assigned to the frames for transmitting necessary data to be used by itself.

Each of these frames that are transmitted to the communication unit 13 by multicast is initially taken into the communication interface 13d and it is determined whether its multicast address is registered in the multicast reception table 13d′. If it is registered, this frame is transmitted to the MPU 13a and the RAM 13c. If it is not registered, the communication interface 13d serves to discard it.

As shown in FIG. 5, for example, if Node (1) has stored data at three virtual memory addresses “1-1”, “1-2” and “1-3” to be transmitted, three transmission frames with multicast addresses “MA1-1”, “MA1-2” and “MA1-3” will be sequentially transmitted from Node (1) to the network cable 21. Since they are transmission frames transmitted by multicast, the switching hub 20, upon receiving them, transmits them to all nodes participating in the network. Thus, as shown in FIG. 7, Node (2) will at first take in all of these transmission frames transmitted from Node (1) by multicast but, as shown in FIG. 6, multicast addresses “MA1-1” and “MA1-2” are registered in the multicast reception table 13d′ of Node(2) while “MA1-3” is not. Thus, the communication interface 13d transfers the registered two frames to the MPU 13a and the RAM 13c and discards the frame with multicast address “MA1-3” that is not registered.

Thus, since unnecessary data (such as those of the frame with address “MA1-3”) for a receiver node (such as Node (2) in the illustrated example) are discarded by the communication interface 13d, the load on the MPU 13a and the CPU unit 12 is not unnecessarily increased. It goes without saying that transmission frames transmitted by multicast from the other nodes (Nodes (3) and (4)) through the switching hub 20 those data transmitted are also all discarded by the communication interface 13d because neither are they registered in the multicast reception table 13d′ of Node (2).

Registration of multicast addresses to the multicast reception table, which is necessary for allowing the communication interface 13d to receive and transmit to the MPU 13a and the RAM 13c only those frames that are required by its own node and to discard unnecessary frames, as well as registration of necessary data for transmitting received data to a specified memory area will be explained next.

A memory map table 13b′ which correlates the addresses (virtual memory addresses) of the virtual memories contained in the frames to be received, the address of the memory in the receiver node for storing the data contained in this frame on the side of the receiver node (receiver real memory address) and the volume of its data (reception size) is set in the ROM 13b of the communication unit 13. The multicast addresses of these frames to be received or data for obtaining these multicast addresses are also stored in the memory map table 13b′ in a correlated form.

The MPU 13a serves to register in the multicast reception table 13d′ the multicast address for obtaining necessary data from those data that are flowing through the network according to the data stored in the memory map table 13b′.

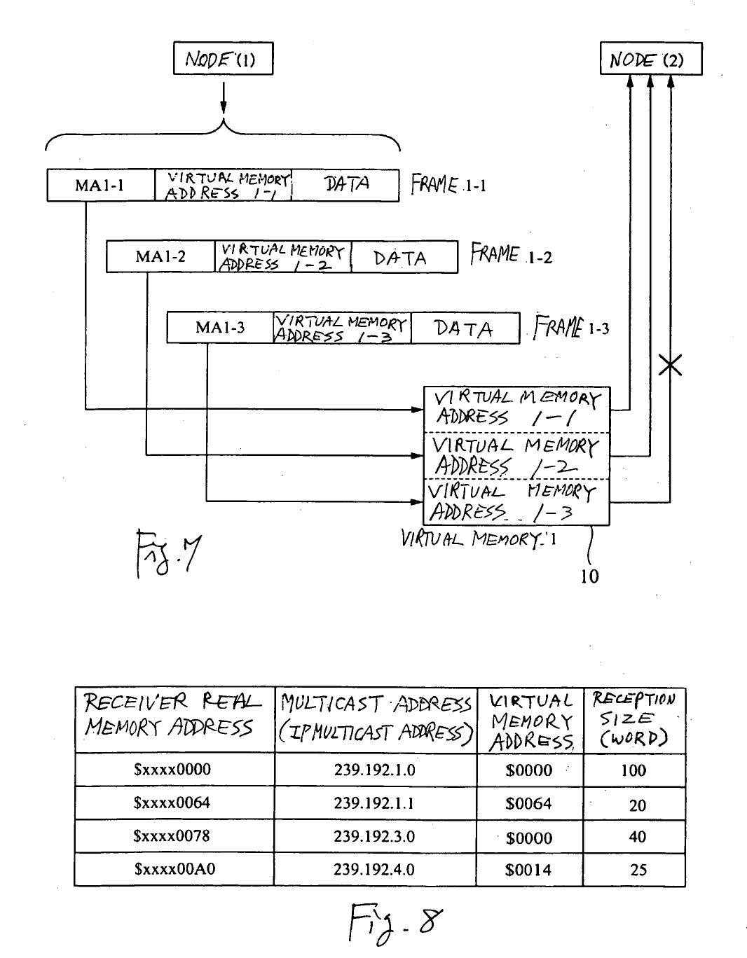

FIG. 8 shows an example of data structure of the memory map table 13b′ correlating the data of the multicast addresses themselves. A shown, this table serves to correlate the receiver real memory address within its own node for recording received data, the multicast address of received frame, the virtual memory address of the source of transmission and the reception size. If the virtual memory address and the multicast address on the transmission side that are necessary for the reception are all stored in the memory map table 13b′ on the receiver side, the multicast address stored in this memory map table 13b′ can be registered in the multicast reception table 13d′ because the multicast address is already known on the side of the receiver node. This registration process is advantageous because it can be carried out without the need of an inquiry from the receiver node to the transmitter node. It is necessary, however, the correlation between the virtual memory address and the multicast address must be strictly established preliminarily both on the side of the transmitter node and on the side of the receiver node.

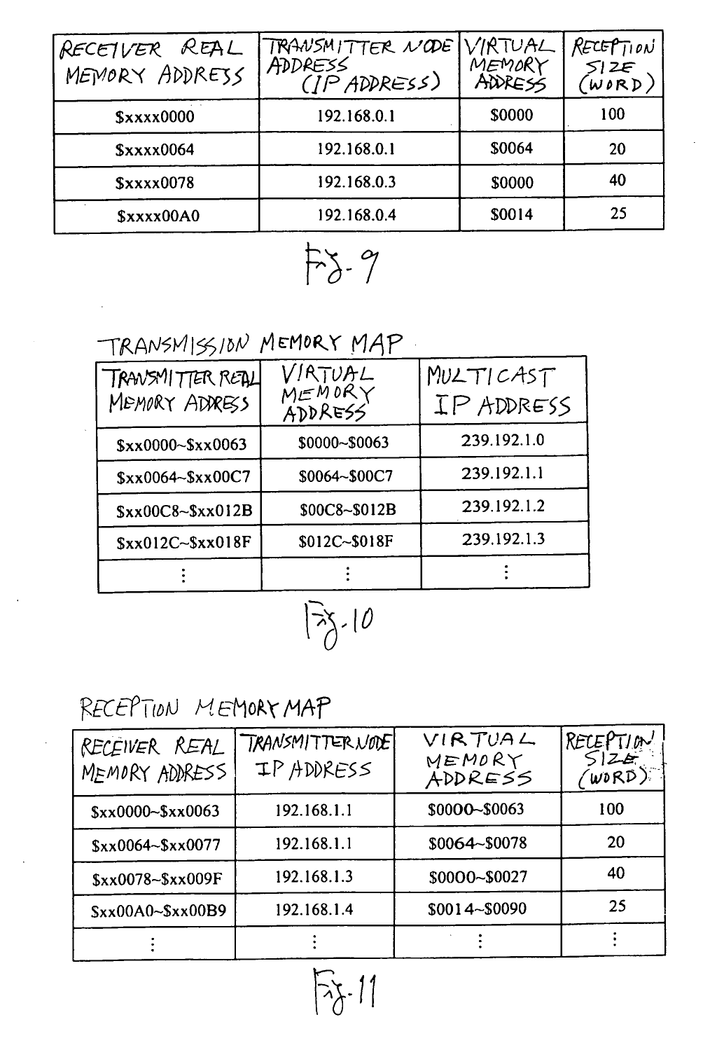

FIG. 9 shows another example of data structure of the memory map table 13b′. This is a table correlating the receiver real memory address within its own node for recording received data, the node address of the transmitter node for specifying the transmitter node transmitting the received frame (such as the IP (internet protocol) address), the virtual memory address of the source of transmission and the reception size. Thus, compared to the example shown in FIG. 8, the node address of the transmitter node is registered instead of the multicast address explicitly.

In the case of a memory map table 13b′ with this data structure, the receiver node must obtain the multicast address of the transmission frame (to be received) which is necessary by itself before the transmission frame is actually transmitted by multicast. For this purpose, an inquiry must be made for the multicast address from the receiver node to the transmitter node based on the transmitter node address stored in the memory map table 13b′ and the virtual address on the transmitter side. Thus, the correlation between the virtual memory address and the multicast address need be established only on the side of the transmitter node.

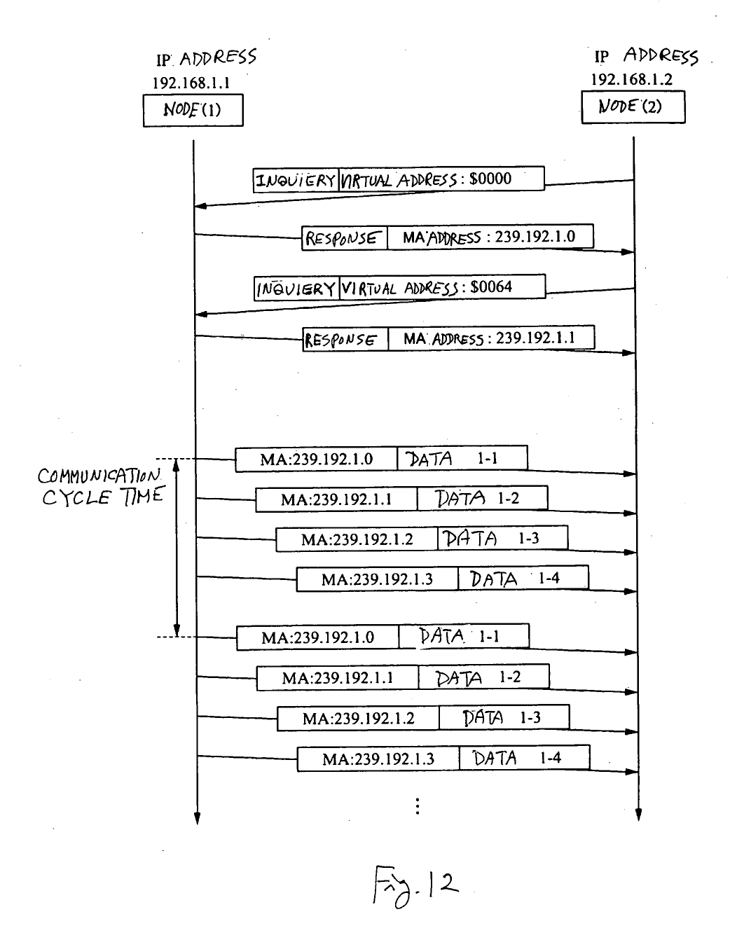

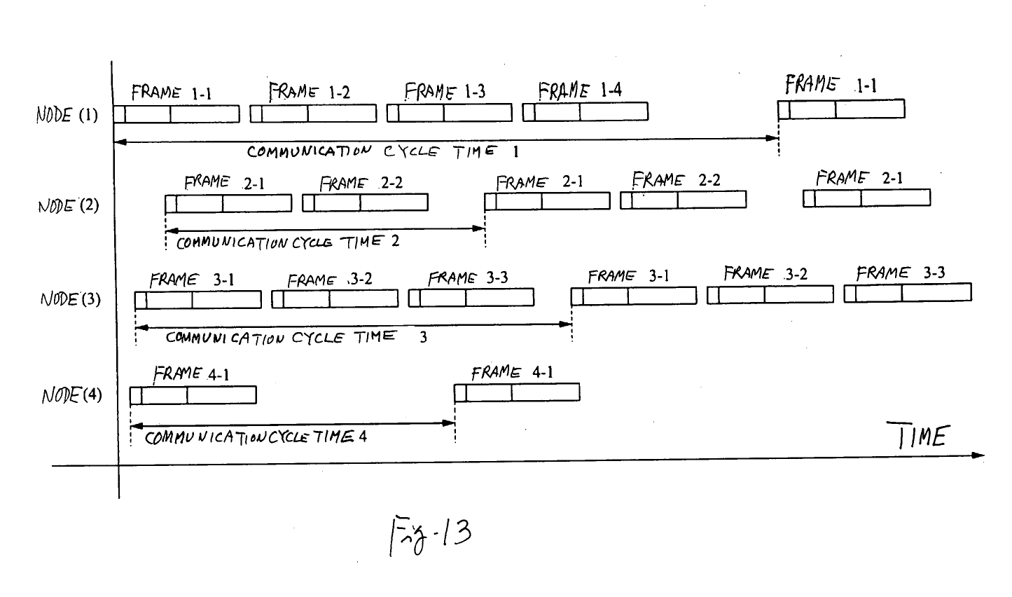

A routine for obtaining the multicast address is explained next. Let us assume that the memory map table 13b′ on the transmitter side and that on the receiver side are respectively as shown in FIGS. 10 and 11. Then, as shown in FIG. 12, an inquiry is transmitted from Node (2) on the receiver side to Node (1) on the transmitter side regarding the multicast address of the data to be received by itself as well as the virtual memory address of the transmitter side. As this inquiry is received, Node (1) on the transmitter side searches its own memory map table (FIG. 10) based on the received virtual memory address, extracts the corresponding multicast address and returns this extracted multicast address to Node (2) on the receiver side as a response. Node (2) on the receiver side registers the received multicast address in its multicast reception table 13d′.

This process of transmitting an inquiry from a node on the receiver side to another node on the transmitter side regarding a multicast address and registering the received multicast address as the response in the multicast reception table is repeated by each node.

After this initial process is completed, a normal communication process is started wherein Node (1) on the transmitter side transmits data sequentially together with multicast addresses and each node on the receiver side receives only those frames that are registered in its multicast address reception table 13d′, discarding the other frames by its communication interface 13d.

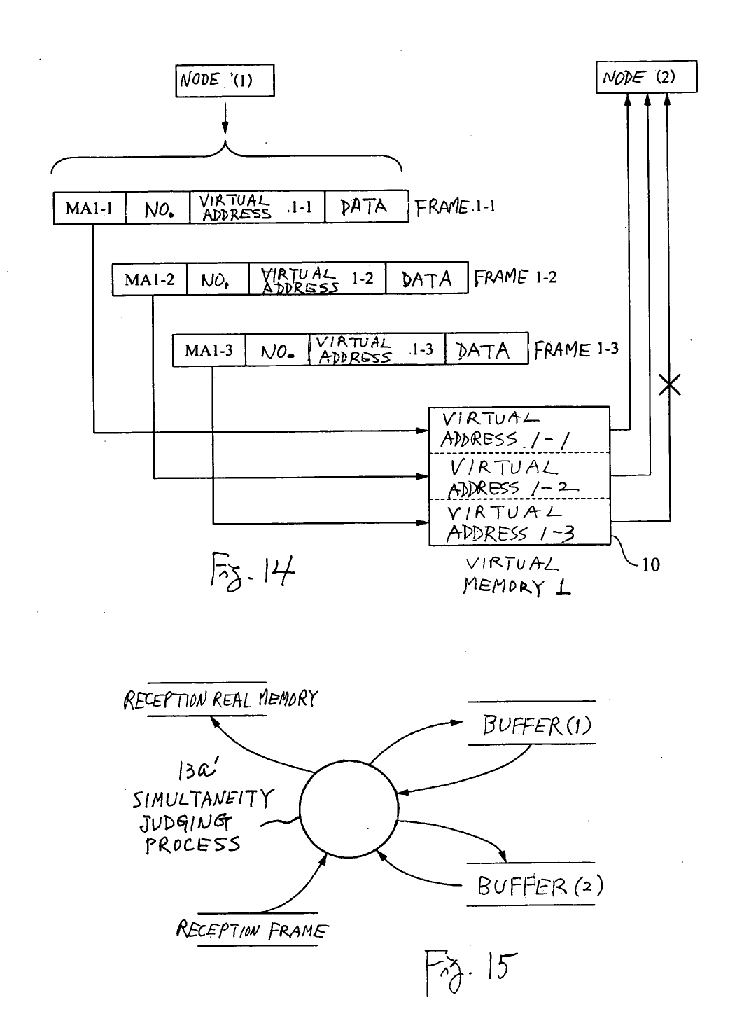

FIG. 13 shows an example of situation where frames are being transmitted, each node sequentially transmitting transmission frames stored in its virtual memory at each of its own communication cycle times. The communication cycle time of each node is determined independent of the quantity of data or the total number of nodes in the network and dependent only upon the number of data to be transmitted by itself. In real situations, however, the maximum transmission capability of each transmitter node, the maximum reception capability of each receiver node, the maximum relaying capability of the switching hub 20, etc. are taken into consideration to determine an optimum communication cycle time for all nodes as a whole.

FIG. 14 shows a portion of another example of this invention.

There are frequently situations where the data transmitted by multicast addresses as explained above are used for equipment control for which simultaneity is required of the received data. In the case of a virtual memory of a large size, for example, it may be necessary to transmit data by dividing them into a plurality of transmission frames. Simultaneity of data means to guarantee or to make certain that data transmitted in a plurality of frames within a communication cycle (such as Frames 1-1, 1-2 and 1-3 transmitted from Node (1)) will be in a condition of being taken out at the same time from a virtual memory (or referred to as the snap shot of data in the virtual memory). If data from different times were mixed together, there would be no simultaneity among the data of Frames 1-1, 1-2 and 1-3 and there would be the danger that a strict control such interlock could not be carried out. Consider a situation where a plurality of data on the virtual memory of Node (1) are used as the condition for an interlock. If these plurality of data are transmitted as data in different frames, this means that a frame of different snapshot is transmitted in each communication cycle. In such a situation, if Node (2) on the receiver side is not capable of ascertaining whether the received frames correspond to the same snapshot or not, data corresponding to different snapshot may be used as the condition for the interlock and the appropriateness of the establishment of the interlock condition may be lost.

In order to guarantee such simultaneity condition, serial numbers are attached to the transmission frames as shown in FIG. 14. The serial numbers according to this invention are counter data which are incremented by 1 each time the communication cycle is renewed such that transmission data belonging to the same communication cycle (such as Frames 1-1, 1-2 and 1-3) take the same value. For example, the serial number “1” is assigned to Frames 1-1, 1-2 and 1-3 which are transmitted within the first communication cycle time and Frames 1-1, 1-2 and 1-3 which are transmitted within the second communication cycle time are assigned the serial number of “2”.

Each node on the receiver side checks the serial numbers stored in the frames that are received and determines whether they are the same or not. After Frames 1-1 and 1-2 have been received, for example, if their serial numbers are the same, it may be judged that they are frames transmitted within the same communication cycle time. If their serial numbers are different, it may be judged that they are frames transmitted in mutually different communication cycle times. Thus, it may be concluded that simultaneity can be guaranteed regarding data stored in frames having the same serial numbers but that it cannot be guaranteed regarding data stored in frames not having the same serial numbers. Only the data having the same serial numbers are accepted as normally received data, the data not having the same serial number being discarded. In this way, the desired simultaneity can be guaranteed. Causes of different serial numbers include noise and errors in the sequence relationship of the frames due to the communication route control.

FIG. 15 is a data flow diagram under the operation explained above with reference to FIG. 14 for guaranteeing the simultaneity of data. Under this mode of operation, frames that are received according to the multicast addresses stored in the multicast address reception table 13d′ are not immediately transferred to the receiver real memory. Instead, the receiver node carries out a serial number control as follows.

In FIG. 15, “received frame” indicates received data transmitted from the communication interface 13d to the MPU 13a and the RAM 13c by passing the multicast filter (or judged as a normal frame registered in the multicast reception table 13d′ by the communication interface 13d). According to the illustrated example, the MPU 13a or the RAM 13c is provided with buffers for temporarily storing received frames, or Buffer (1) and Buffer (2) for recording and storing Frames 1-1 and 1-2 with multicast addresses MA1-1 and MA1-2.

The MPU 13a is provided with a simultaneity judging part 13a′. When a regular frame (that has passed a multicast filter) is received, the simultaneity judging part 13a′ serves to compare it with the serial number of the frame which was earlier received and stored in the buffer and thereby determines whether the simultaneity condition is satisfied. If it is determined that the simultaneity condition is satisfied, the data in the data part of the frame are stored in a memory area of a reception real memory 13c′ inside the RAM 13c set by the memory map table 13b′. Thus, the reception real memory 13c′ comes to store only the data from normally received frames and the required simultaneity condition is satisfied.

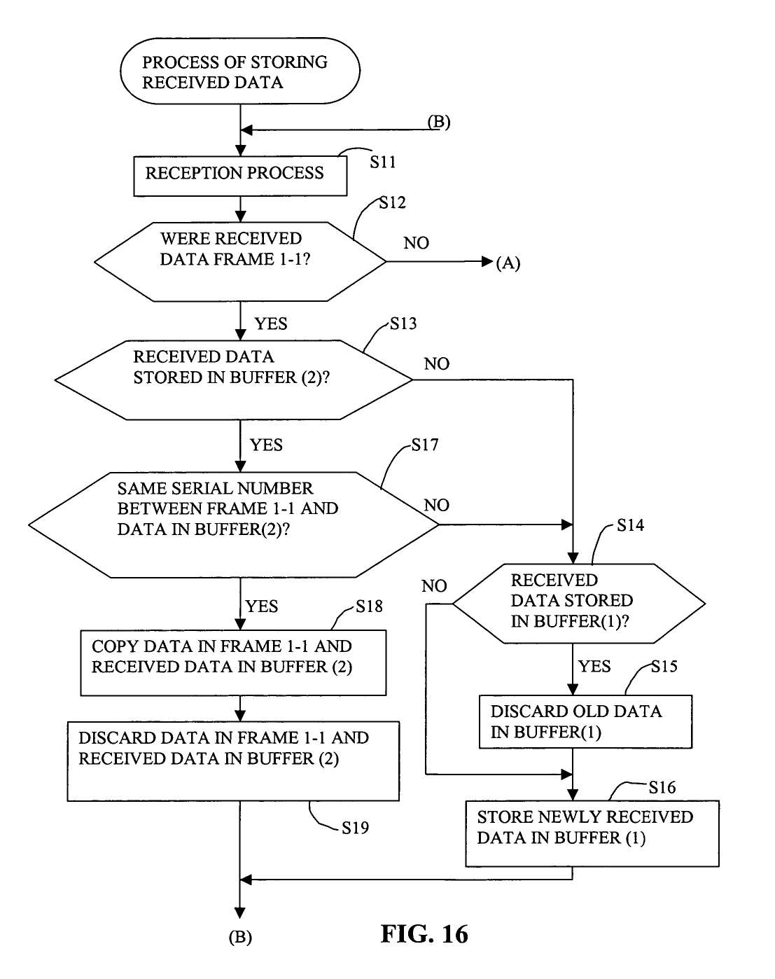

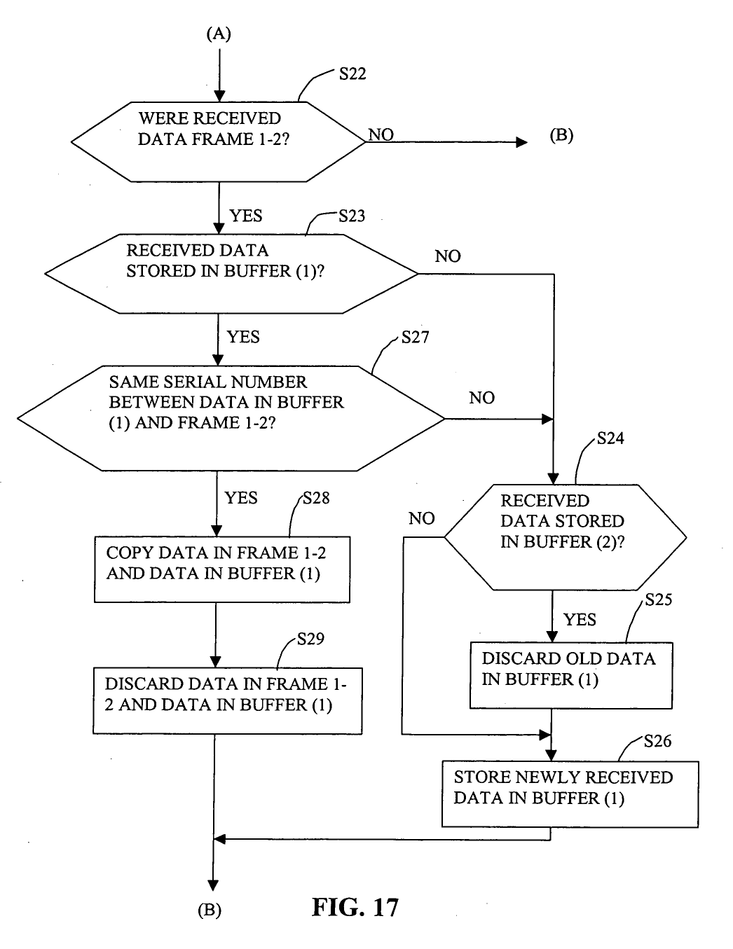

FIGS. 16 and 17 show the functions of the simultaneity judging part 13a′ in detail. For the convenience of description, this flowchart is for the simultaneity judging part 13a′ of Node (2) and it is the two frames 1-1 and 1-2 with multicast addresses MA1-1 and MA1-2 that are required to satisfy the simultaneity condition.

As the simultaneity judging part 13a′ receives a frame transmitted by multicast to the communication interface 13d and judged by the multicast reception table 13d′ to be a normal frame addressed to its own node (Step S11), it is firstly determined whether the received frame is Frame 1-1 or not (Step 12). If it is determined to be Frame 1-1 (YES in Step 12), it is judged whether received data are stored in Buffer (2) or not (Step ST13). If it is determined that Buffer (2) does not store any received data (NO in Step ST13), it is further determined whether any received data are stored in Buffer (1) or not (Step ST14). If any earlier received data are found to be still stored in Buffer (1) (YES in Step ST14), the old data in Buffer (1) are discarded (Step ST15) and the newly received data are stored instead in Buffer (1) (Step ST16). If no earlier received data are found to be stored in Buffer (1) (NO in Step ST14), the newly received data are directly stored in Buffer (1) (Step ST16).

If any already received data are found to be stored in Buffer (2) (YES in Step 13), the simultaneity judging part 13a′ serves to compare the serial number of the reception frame of the data found to be already stored in Buffer (2) with that of the newly received frame (Step 17). If they are judged to be the same (YES in Step S17), both of these reception frames are copied into the reception real memory (Step S18) since it may then be concluded that they were both transmitted within the same communication cycle time. The newly received data and the data temporarily stored in Buffer (2) are thereafter discarded by the simultaneity judging part 13a′ (Step S19).

If the serial numbers of the newly received frame and that which was found to be stored in Buffer (2) are judged to be different (NO in Step S17), the steps after Step S14 are repeated.

If the received data are not Frame 1-1 (NO in Step S12), it is determined whether the received data are Frame 1-2 (Step S22). If the received data are Frame 1-2 (Yes in Step S22), it is judged whether received data are stored in Buffer (1) (Step S23). If it is judged that Buffer (1) does not store any received data (NO in Step S23), it is determined whether Buffer (2) stores any received data (Step S24). If it is determined that earlier received data are stored in Buffer (2) (YES in S24), these earlier received data are discarded (Step S25) and the newly received data are stored in Buffer (2) (Step S26). If Buffer (2) is judged as storing no earlier received data (NO in Step S24), the newly received data are directly stored in Buffer (2) (Step S26).

If it is determined that Buffer (1) already stores earlier received data (YES in Step S23), the simultaneity judging part 13a′ serves to compare the serial number of the reception frame of the data found to be stored in Buffer (1) with that of the frame of the newly received data (Step S27). If they are judged to be the same (YES in Step S27), both of them are copied into the reception real memory (Step S28) because it may be concluded that both Frame 1 -1 and Frame 1-2 were received within the same communication cycle time. Both Frame 1-2 which has just been received and the data stored in Buffer (1) are thereafter discarded (Step S29).

If the serial number of Frame 1-2 which has been received and that of the frame stored in Buffer (1) are different (NO in Step S27), the steps from Step S24 are repeated.

If the received data are neither Frame 1-1 nor Frame 1-2 (NO in Step S22), the process returns to Step S11 and the simultaneity judging part 13a′ will wait for the next reception. In this case, data processing of a different kind and protocol processing will be carried out.

Since the transmitter node (such as Node (1)) usually transmits in the order of firstly Frame 1-1 and secondly Frame 1-2, it may be assumed that the receiver node (such as Node (2)) will always receive Frame 1-1 first. Thus, it may be considered sufficient to provide only Buffer (1) in the case of the example described above. In the internet protocol (IP), however, the arrival relationship among communication data of the datagram type used in multicast cannot always be certain and hence the frames transmitted in the same cycle time need not necessarily be received in the same order and there may be situations where Frame 1-2 is received first. This is why Buffer (2) was also provided in the example described above.

Although FIGS. 15-17 were referenced to explain only a simple example with only two reception frames but it goes without saying that there are situations where three or more reception frames are required to satisfy the simultaneity condition. In such a situation, the number of buffers must be appropriately changed and the routine shown in FIGS. 16 and 17 may have to be modified accordingly.

What is claimed is:

1. A network system comprising a network and a plurality of nodes connected thereto, said nodes having data shared in common among said nodes;
said nodes each having a communication interface for transmission and reception of data by full duplex transmission through said network;
said nodes each having a virtual memory for storing data to be transmitted by said node, said data to be transmitted having multicast addresses set thereto in units of frames;
the communication interface, when the node corresponding thereto is transmitting data, serving to transmit said data by multicast together with the multicast addresses corresponding to said transmitted data;
each of said nodes, when data to be received thereby are set, serving to store one or more of multicast addresses of frames containing data to be transmitted from other nodes by multicast and to be received thereby; and
the communication interface of each of said nodes serving, when receiving frames transmitted by multicast, to copy to the corresponding node the data of those of said received frames having a multicast address that matches one of the stored multicast addresses and to discard frames with a multicast address that does not match any of the stored multicast addresses.

2. The network system of claim 1 wherein said network is an Ethernet network.

3. A node adapted to be connected to a network and to share data in common with other nodes connected to said network, said node comprising;
a communication interface for transmission and reception of data by full duplex transmission through said network;
a virtual memory for storing data to be transmitted by the node and multicast addresses in correlation; and
a memory for storing multicast addresses of frames containing those of the data transmitted by multicast from other nodes that are to be received by itself;
wherein said communication interface serves to transmit data by multicast together with said stored multicast addresses and, when frames transmitted by multicast are received, to copy to the node the data in those of said received frames having a multicast address that matches one of said stored multicast addresses and to discard data in those of said received frames having a multicast address not matching any of said stored multicast addresses.

4. A data communication method using a network system with a network and a plurality of nodes connected to said network and adapted to share data in common among said nodes, said method comprising the steps of:
providing each of said nodes with a communication interface for transmission and reception of data by full duplex transmission through said network;
providing each of said nodes with a virtual memory for storing data to be transmitted by said node;
setting multicast addresses to data in units of frames for transmission;
causing the communication interface of one of said nodes to transmit by multicast the data for transmission together with said set multicast addresses;
causing each of said nodes for which data to be received are set, to store multicast addresses of frames containing data that are transmitted from other nodes and intended to be received by said each node; and
causing the communication interface of each of said nodes, when data are thereby received by multicast, to copy to the corresponding node the data contained in those of the frames transmitted by multicast and having a multicast address that matches one of said stored multicast addresses and to discard data in those of said received frames having a multicast address not matching any of said stored multicast addresses.

5. The data communication method of claim 4 further comprising the steps of:
causing each of said nodes to transmit data by assigning a same identification number to a plural number of frames; and
causing each of said nodes, when receiving data, to copy said received data to said each node only after data in said plural number of frames have been received.

6. The data communication method of claim 4 further comprising the steps of:
causing each of said nodes to record node-identifying data for identifying a data-transmitting node that transmits data to be received by itself and address data of the virtual memory of said data-transmitting node; and
causing an inquiry to be made to said data-transmitting node regarding multicast address based on said recorded address data and obtaining said multicast address.

7. The data communication method of claim 5 further comprising the steps of:
causing each of said nodes to record node-identifying data for identify a data-transmitting node that transmits data to be received by itself and address data of the virtual memory of said data-transmitting node; and
causing an inquiry to be made to said node transmitting data regarding multicast address thereof based on said recorded address data and obtaining said multicast address.

8. A network system comprising a network and a plurality of nodes connected thereto through a switching hub, said nodes having data shared in common among said nodes;
said nodes each having a communication interface for transmission and reception of data by full duplex transmission through said network;
said nodes each having a virtual memory for storing data to be transmitted by said node, said data to be transmitted having multicast addresses set thereto in units of frames;
the communication interface, when the node corresponding thereto is transmitting data, serving to transmit said data by multicast together with the multicast addresses corresponding to said transmitted data;
each of said nodes, when data to be received thereby are set, serving to store one or more of multicast addresses of frames containing data to be transmitted from other nodes by multicast and to be received thereby;
the communication interface of each of said nodes serving, when receiving frames transmitted by multicast, to copy to the corresponding node the data of those of said received frames having a multicast address that matches one of the stored multicast addresses and to discard frames with a multicast address that does not match any of the stored multicast addresses; and
each of said nodes serving to transmit data cyclically at transmission timing of itself to thereby share the transmitted data with the others of said nodes.

9. The network system of claim 8 wherein each of said nodes is adapted, when transmitting data by dividing said data into a plural number of frames within a same communication cycle, to assign a same identification number to said frames and, when receiving data, to copy said received data to said each node only after data in a number same as said plural number of frames have been received.
